(19) United States
(12) Patent Application Publication
(10) Pub. No.: US 2025/0082973 A1
(43) Pub. Date: Mar. 13, 2025

(54) FIRE SUPPRESSION TANK FOR ELECTRIC VEHICLE CHARGING STATION

(71) Applicant: HANKOOK FIRE FIGHTING EQUIPMENTS CO.,LTD., Daegu (KR)

(72) Inventor: Soo Hwan CHEONG, Daegu (KR)

(73) Assignee: HANKOOK FIRE FIGHTING EQUIPMENTS CO.,LTD., Daegu (KR)

(21) Appl. No.: 18/289,088

(22) PCT Filed: Oct. 11, 2022
(86) PCT No.: PCT/KR2022/015278

§ 371 Date: Oct. 31, 2023

(30) Foreign Application Priority Data
Jun. 17, 2022 (KR) 10-2022-0074326

(51) Int. Cl. A62C 3/16; A62C 3/07; B60L 53/30

(52) U.S. Cl. CPC A62C 3/16; A62C 3/07; B60L 53/30

(57) ABSTRACT

A fire suppression tank of an electric vehicle charging station, includes: a tube storage part provided at a parking position of the electric vehicle charging station to surround an entering vehicle. The tube storage part includes a storage body in which a receiving groove having a certain width and depth is formed along an edge thereof, and an air injection type multi-wall tube having a central hole is fitted and accommodated in the storage body. An upper opening of the storage body is opened or closed by a cover. As air is injected into the air injection type multi-wall tube to inflate the air injection type multi-wall tube. The cover is automatically opened, so that the inflated air injection type multi-wall tube forms the tank to surround the vehicle from all sides. A battery of the electric vehicle is submerged to be stabilized by filling the tank with water.

### CROSS-REFERENCE TO PRIOR APPLICATIONS

This Application is a National Stage Patent Application of PCT International Application No. PCT/KR2022/015278 (filed on Oct. 11, 2022), which claims priority to Korean Patent Application No. 10-2022-0074326 (filed on Jun. 17, 2022), which are all hereby incorporated by reference in their entirety.

### BACKGROUND

The present disclosure relates to a fire extinguishing device and, more particularly, to a fire suppression tank for an electric vehicle charging station, which can detect and early extinguish a fire in the event of the fire occurring in the electric vehicle charging station.

Various large buildings or facilities are required to be equipped with various fire extinguishing facilities, such as fire hydrants, sprinklers, or watering systems, in accordance with the Fire Services Act and Building Act. However, a small space where the fire extinguishing facility is not required by law, especially a pit space containing electrical or communication facilities such as EPS or TPS is inevitably vulnerable to fire suppression in the event of a fire. Because of this problem, a separate automatic fire extinguishing device for the small space is installed in a position where there is a high risk of fire in the small space so as to prepare for fires.

In addition, as the spread of an electric vehicle increases recently, an electric vehicle charging station is essentially installed in an underground parking lot of a newly built apartment, and there is a trend for the electric vehicle charging station to be installed in a large parking lot of a government office or park.

However, fires often occur in the electric vehicle charging station. This may be caused by the abnormal operation of a battery or a charging device. In addition, this may be caused by an abnormal operation between the battery and the charging device. This abnormal operation may cause a fire even if only one of the above reasons is a problem.

Generally, sprinklers are installed at regular intervals in the apartment underground parking lot. However, the sprinklers cannot trace an exact ignition point, thus making it impossible to early detect a fire. In particular, when the fire occurs in the electric vehicle charging station, it is difficult to quickly extinguish the fire using the sprinklers, and water that may be sprayed is limited, so continuous spraying is restricted. Further, the general sprinkler cannot intensively spray water toward the point of fire, so it is difficult to effectively extinguish the fire and thereby the sprinkler has limitations in quickly extinguish the fire.

### SUMMARY

Accordingly, the present disclosure provides a fire suppression tank for an electric vehicle charging station, which detects a fire in the event of the fire while charging an electric vehicle and enables the fire to be quickly extinguished in an early stage.

In order to accomplish the above-mentioned object, the present disclosure provides a tank to quickly stabilize a battery in the event of a fire while charging an electric vehicle.

The tank includes a quadrilateral frame-shaped tube storage part 10 provided at a parking position of the electric vehicle charging station to surround an entering vehicle.

The tube storage part 10 includes a storage body 12 in which a receiving groove 12a having a certain width and depth is formed along an edge thereof, and an air injection type multi-wall tube having a central hole 20a is fitted and accommodated in the storage body 12.

An upper opening of the storage body 12 is opened or closed by an opening/closing cover 14, and, as air is injected into the air injection type multi-wall tube 20 to inflate the air injection type multi-wall tube, the opening/closing cover 14 is automatically opened, so that the inflated air injection type multi-wall tube 20 forms the tank to surround the vehicle from all sides.

A battery of the electric vehicle is submerged to be stabilized by filling the tank with water.

According to the present disclosure, a separate tank is provided at an electric vehicle charging position to detect a fire in the event of the fire and immediately fill the tank with water, thereby causing a battery to be submerged and quickly stabilized and allowing the fire to be extinguished early.

### BRIEF DESCRIPTION OF THE DRAWINGS

FIGS. 1A-1C illustrate the configuration and operation of a fire suppression tank 2 for an electric vehicle charging station according to an embodiment of the present disclosure.

FIG. 2 is a diagram illustrating the configuration of a tube storage part 10 forming the fire suppression tank 2 for the electric vehicle charging station.

FIGS. 3A and 3B illustrate the configuration of an air injection type multi-wall tube 20 forming the fire suppression tank 2 for the electric vehicle charging station.

FIG. 4 is a diagram illustrating the configuration of another embodiment of an opening/closing cover 14 forming the tube storage part 10.

### DETAILED DESCRIPTION

Hereinafter, a preferred embodiment of the present disclosure will be described in detail with reference to the accompanying drawings.

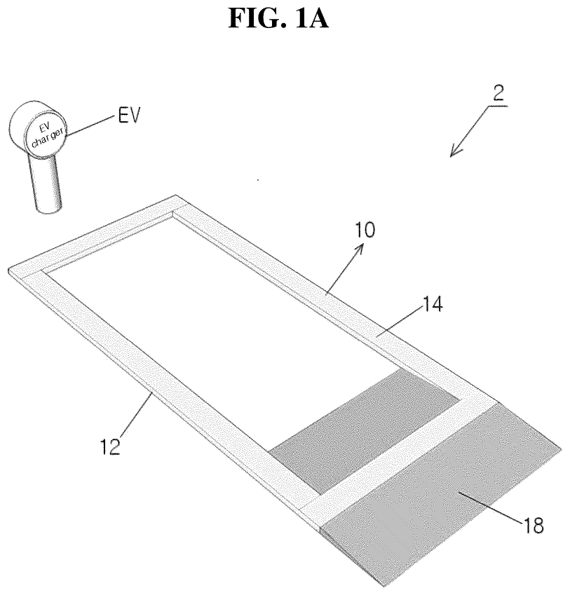

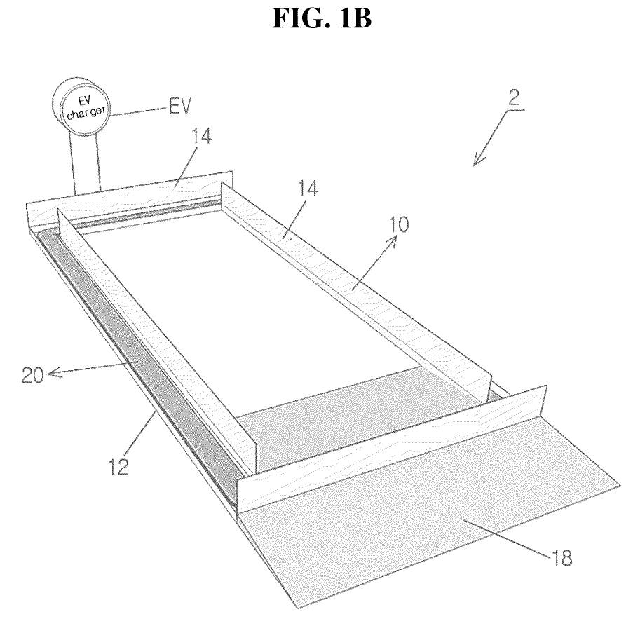

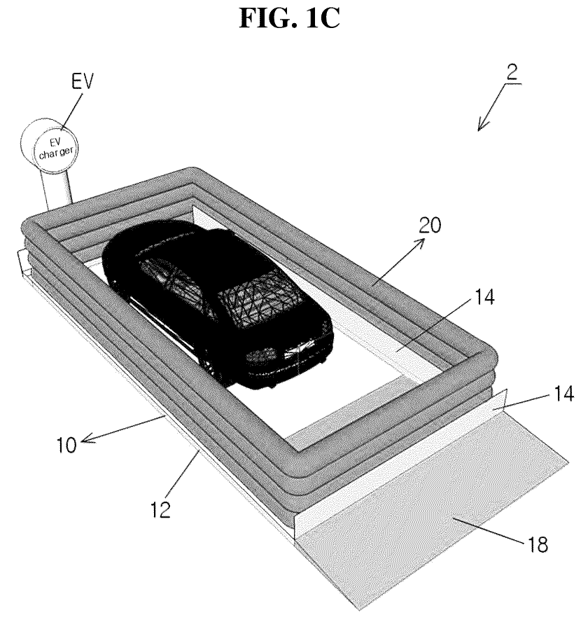

Referring to FIGS. 1A-1C, a fire suppression tank 2 is provided at a parking position of an electric vehicle charging station according to an embodiment of the present disclosure.

The fire suppression tank 2 for the electric vehicle charging station forms a quadrilateral frame-shaped tube storage part 10 to surround an entering vehicle. A vehicle access road is formed on a side of the tube storage part 10, and a slope plate 18 is installed on the access road to ensure the smooth entry of the vehicle and to protect the tube storage part 10 from the load of the vehicle. A charger EV is located on the opposite side of the access road.

The tube storage part 10 has a storage body 12 in which a receiving groove 12a having a certain width and depth is formed along an edge thereof, and an air injection type multi-wall tube having a central hole 20a is accommodated in the storage body 12.

An upper opening of the storage body 12 may be opened or closed by an opening/closing cover 14, and is normally closed to protect the storage body in a state where the deflated air injection type multi-wall tube 20 is accommodated therein.

In the event of fire, the air injection type multi-wall tube 20 is inflated as air is injected therein. At this time, the opening/closing cover 14 is automatically opened. Further, the inflated air injection type multi-wall tube 20 forms the tank to surround the vehicle from all sides. By filling the tank with water, the battery of the electric vehicle is submerged to be stabilized.

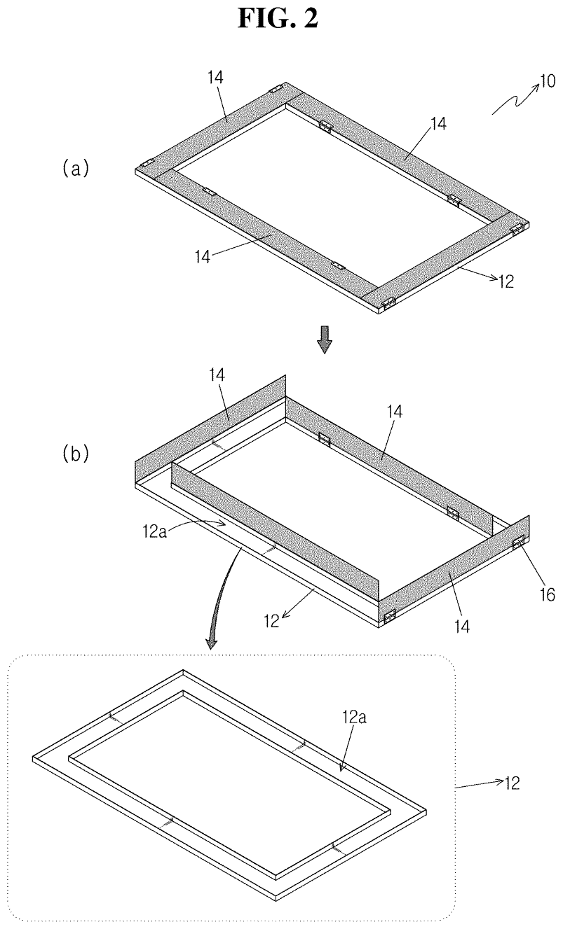

Referring to FIG. 2, when the opening/closing cover 14 for opening or closing the upper end of the storage body 12 of the tube storage part 10 is coupled to the storage body 12 via a hinge 16, the opening/closing cover may be automatically opened when air is injected into the air injection type multi-wall tube 20. Here, it is preferable to install a stopper so that the portion of the hinge 16 does not move beyond 90° when the opening/closing cover 14 is changed from a closed state to an open state.

The height of the air injection type multi-wall tube 20 may be approximately 1m. This height allows the battery to be sufficiently submerged as water is filled and prevents, to some extent, fire from being transferred to a vehicle next to the vehicle in the event of fire. The lower end of the air injection type multi-wall tube 20 is tightly coupled to the inner bottom surface of the storage body 12 to make it waterproof.

The air injection type multi-wall tube 20 is normally folded with the air being released, and then is inflated as the air is injected, thus forming a wall to surround the electric vehicle. In order to inject the air into the air injection type multi-wall tube 20, one or more separate air inlets 24 may be provided. The air inlet 24 may be connected though a hose to a cylinder or compressor filled with compressed air to automatically inject the air in the event of fire. Preferably, it is economical and easy to connect the air inlet to the cylinder, and the cylinder is equipped with a solenoid valve to automatically open the valve when the fire is detected.

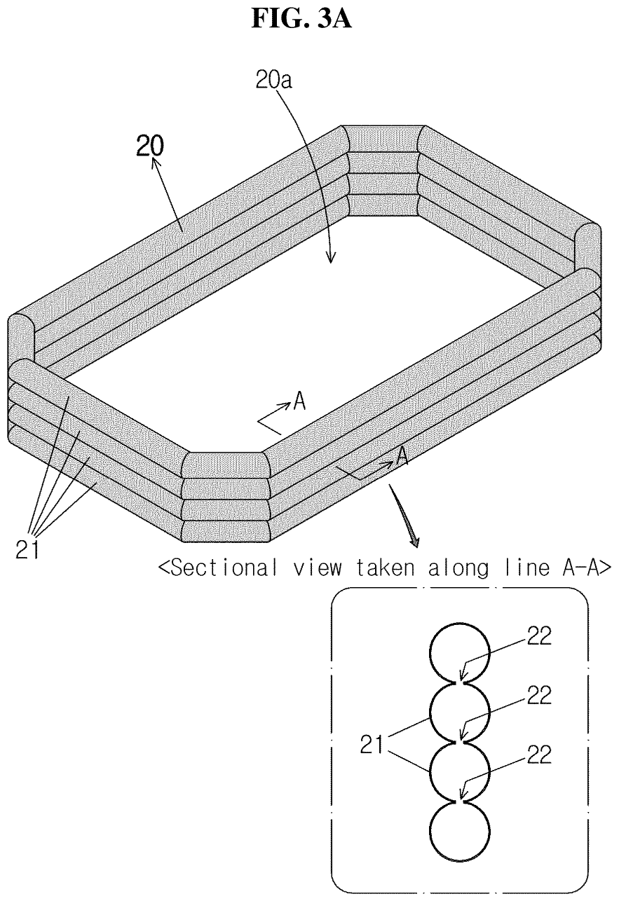

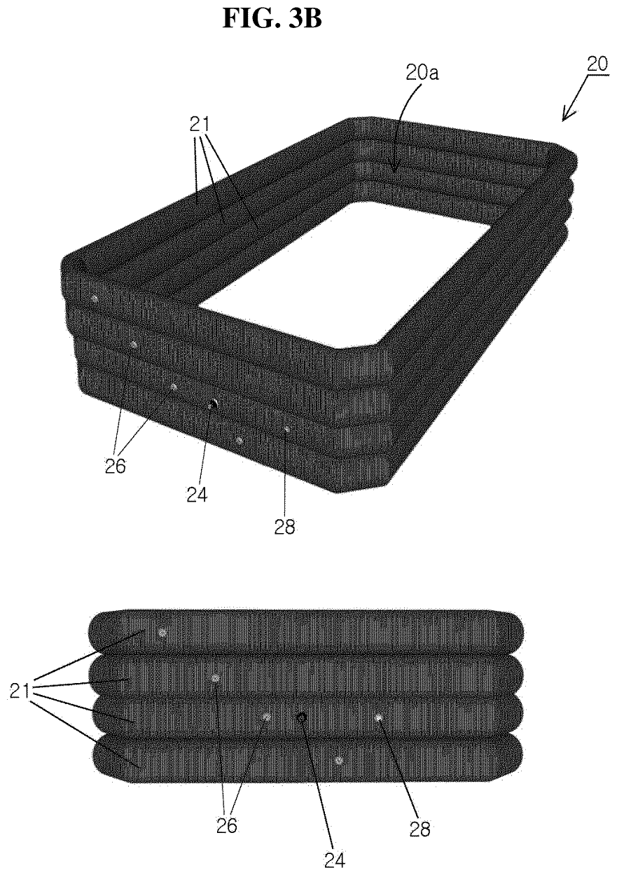

In particular, the air injection type multi-wall tube 20 is formed by vertically stacking a plurality of individual unit tubes 21 and coupling the tubes with each other. Further, as shown in FIG. 3A, between the unit tubes 21 that are adjacent to each other in a vertical direction, a plurality of communication passages 22 are formed to be spaced apart from each other. Thus, air is injected therein, starting from the unit tube 21 located at the lower end to the unit tube 21 located at the upper end, thereby erecting the wall.

The air injection type multi-wall tube 20 has a separate air outlet 26 on the outer wall. Thus, when a battery stabilizing operation is completed, the tube may be collapsed for storage after the air is discharged. If the air outlet 26 is installed in each unit tube 21, air can be more rapidly discharged. In addition, the air injection type multi-wall tube 20 may be provided with an overpressure outlet 28 so as to prevent bursting due to overpressure when the air is injected.

In order to quickly fill the fire suppression tank 2 with water and thereby cause the vehicle battery to be submerged in the event of fire, a water supply unit may be provided on at least one of the bottom of a location where a separate electric vehicle enters or the top of the constructed tank. Further, water can be filled in various methods, such as by filling water through a hose of a nearby fire hydrant or by using fire-fighting water.

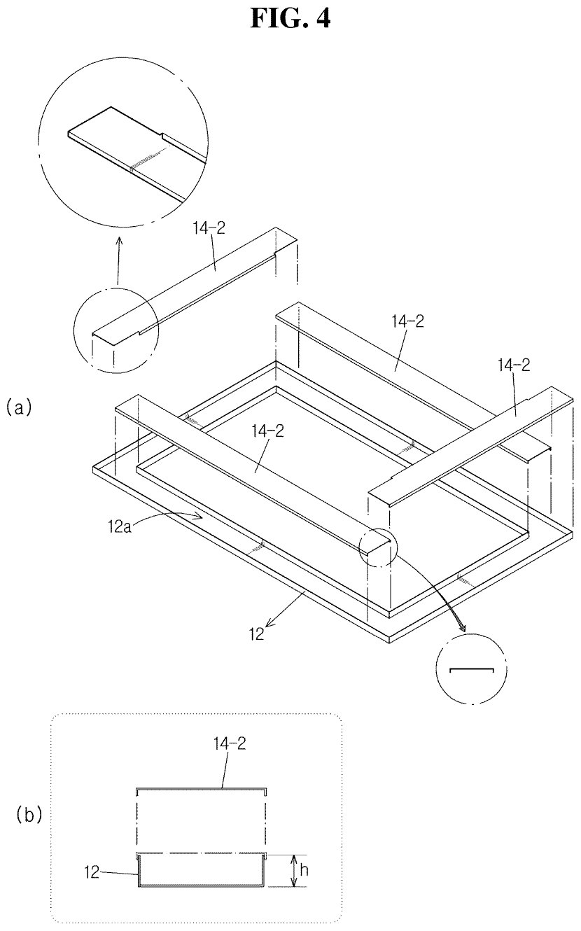

FIG. 4 is a diagram illustrating the configuration of another embodiment of an opening/closing cover 14 forming the tube storage part 10. That is, an opening/closing cover 14-2 according to another embodiment may be configured in the shape of [symbol] to cover the upper opening of the storage body 12. This configuration also allows the cover to be automatically opened when air is injected into the air injection type multi-wall tube 20.

In the present disclosure, when setting the height h of the storage body 12, it can be set relatively high to prevent the electric vehicle from going over the storage body without the slope plate 18. In this case, when the electric vehicle enters the fire suppression tank 2, it enters only through the access road where the slope plate 18 is installed, so that parts other than the access road are naturally protected.

Although a preferred embodiment of the present disclosure has been described for illustrative purposes, those skilled in the art will appreciate that various modification, additions and substitutions are possible, without depart from the scope and spirit of the invention as disclosed in the accompanying claims.

The present disclosure is installed in a charging station for an electric vehicle to quickly extinguish fire in an early stage in the event of the fire.

1. A fire suppression tank of an electric vehicle charging station, the tank comprising:
a quadrilateral frame-shaped tube storage part provided at a parking position of the electric vehicle charging station to surround an entering vehicle,
wherein the tube storage part comprises a storage body in which a receiving groove having a certain width and depth is formed along an edge thereof, and an air injection type multi-wall tube having a central hole is fitted and accommodated in the storage body,
wherein an upper opening of the storage body is opened or closed by an opening/closing cover, and, as air is injected into the air injection type multi-wall tube to inflate the air injection type multi-wall tube, the opening/closing cover is automatically opened, so that the inflated air injection type multi-wall tube forms the tank to surround the vehicle from all sides, and
wherein a battery of the electric vehicle is submerged to be stabilized by filling the tank with water.

2. The fire suppression tank of claim 1, wherein the opening/closing cover is coupled to the storage body via a hinge to be pivotably opened or closed, or is configured in a shape of [symbol] to cover the upper opening of the storage body.
